(19) United States
(12) Patent Application Publication
(10) Pub. No.: US 2010/0035094 A1
(43) Pub. Date: Feb. 11, 2010

(54) Hydrophilic Inorganic Aggregate, A Method for Preparing the Same, Hydrophilic Composite Material and Bipolar Plate for Fuel Cell Comprising the Same

(75) Inventors: Sung Jun KIM, Uiwang-si (KR); Chang Min HONG, Uiwang-si (KR)

Correspondence Address: SUMMA, ADDITON & ASHE, P.A., 11610 NORTH COMMUNITY HOUSE ROAD, SUITE 200, CHARLOTTE, NC, 28277, US

(73) Assignee: Cheil Industries, Gumi-si (KR)

(21) Appl. No.: 12/488,813

(22) Filed: Jun. 22, 2009

Related U.S. Application Data
(63) Continuation-in-part of application No. PCT/KR2006/005855, filed on Dec. 28, 2006.

(30) Foreign Application Priority Data
Dec. 20, 2006 (KR) 10-2006-0131388

(51) Int. Cl. H01M 4/00; H01B 1/24; H01M 8/00

(52) U.S. Cl. 429/12; 252/511; 977/742

(57) ABSTRACT

Disclosed herein are a hydrophilic inorganic aggregate, a method for preparing the same, and a hydrophilic composite and a fuel cell bipolar plate, each comprising the same. The hydrophilic inorganic aggregate comprises hybrid particles in which carbon black particles are embedded on the surface of hydrophilic inorganic particles.

### CROSS-REFERENCE TO RELATED APPLICATIONS

This non-provisional application is a continuation-in-part application of PCT Application No. PCT/KR2006/005855, filed Dec. 28, 2006, pending, which designates the U.S. and which is hereby incorporated by reference in its entirety, and claims priority there from under 35 USC Section 120. This application also claims priority under 35 USC Section 119 from Korean Patent Application No. 10-2006-0131388, filed Dec. 20, 2006, the entire disclosure of which is also hereby incorporated by reference.

### FIELD OF THE INVENTION

The present invention relates to a hydrophilic inorganic aggregate, a hydrophilic composite comprising the same, a fuel cell bipolar plate comprising the same, and a method for preparing the same.

### BACKGROUND OF THE INVENTION

Fuel cells are electricity generating systems which directly convert chemical energy into electrical energy via an electrochemical reaction between hydrogen (H₂) contained in a hydrocarbon material, such as methanol or natural gas, and oxygen (O₂) in air. Fuel cells are high-efficient clean energy converters that use electricity generated by the electrochemical reaction between a fuel gas and an oxidizing gas, and heat as a by-product thereof, without any combustion. Fuel cells have attracted considerable attention as a next-generation energy source owing to their advantages of high-efficient energy conversion, and environmental-friendliness, i.e., being free from contaminants.

A fuel cell, such as for example a polymer electrolyte membrane fuel cell (PEMFC), may include a membrane-electrode assembly consisting of a polymeric electrolyte membrane, also referred to as a “Proton exchange membrane”, and each of an anode and cathode gas diffusion layer as an electrode arranged on opposite sides of the polymer electrolyte membrane. Also, the fuel cell may include fuel cell anode and cathode bipolar plates deposited on opposite sides (i.e. the positive and negative electrodes), respectively, of the membrane-electrode assembly.

The main operation mechanism of the fuel cell will be described hereinafter.

A fuel gas, including hydrogen (H₂), is supplied from a gas flow channel in the anode bipolar plate. Hydrogen (H₂), acting as the fuel gas, loses electrons in the positive electrode and becomes hydrogen ions. The hydrogen ions move through the polymeric electrolytic membrane to the negative electrode (cathode). The electrons released from hydrogen are also introduced into the negative electrode via an external circuit.

Meanwhile, an oxidizing gas, including oxygen (O₂), is supplied from a gas flow channel in the negative bipolar plate. The oxidizing gas is reduced by the electrons to become an oxygen ion (O²⁻). The oxygen ion reacts with the hydrogen ions (H⁺) introduced into the negative electrode via the polymeric electrolytic membrane to generate water (H₂O). This water, together with the remaining oxidizing gas, is discharged through the gas flow channel in the negative bipolar plate. In the process of repeated electrochemical reactions, electrons flow through the external circuit, thereby generating electricity.

In the fuel cell, the bipolar plates, which are one of the electrically conductive plates, transport fuel gas, oxidizing gas, and electrons and water generated by the electrochemical reaction. In addition, the bipolar plates support the overall fuel cell stack. It has been known that the bipolar plates must have a desired level of electrical conductivity and flexural strength.

To ensure favorable movement of hydrogen ions generated at the positive electrode, the humidity of hydrogen ions must be continuously adjusted to a desired level. In addition, humidity of the polymeric electrolyte membrane must be maintained at a desired level. To maintain the humidity, hydrophilization of bipolar plates may favorably affect the ionic conductivity of hydrogen. The polymeric electrolyte membrane has a disadvantage of vulnerability to heat. Accordingly, in a case where a fuel cell is operated at a relatively high temperature, the bipolar plate of the fuel cell, in addition to the polymeric electrolyte membrane thereof, is preferably hydrophilized to protect the polymeric electrolyte membrane against the high temperature.

In a case where an electrically-polarized fuel gas is transferred through the gas flow channel in the bipolar plate, the fuel gas, polar water, and a residual ionomer derived from the polymer made of the bipolar plate conglomerate together, thus causing an elevation in fluid flow resistance of the flow channel, i.e., “water slugs”. The water slugs induce formation of precipitates, thus allowing the flow channel to be blocked. However, the hydrophilization of bipolar plates induces formation of a thin water-film on the surface of the flow channel, and thus prevents the water slugs from occurring. In the hydrophilized bipolar plates, moisture in hydrogen ions introduced from the positive electrode is formed into water drops on the negative electrode, thereby inhibiting a waterdrop effect obstructing the flow of oxidizing gas, and enabling water to be favorably discharged through the gas flow channel in the negative bipolar plate due to the water-film formation.

Based on the above-mentioned advantages, there have been repeated attempts and research associated with hydrophilization of a bipolar plate. Of these, a simple addition of a hydrophilic inorganic material to a bipolar plate has been suggested. In this case, the addition of the inorganic material causes deterioration in the electrical conductivity of the bipolar plate.

Also, the use of carbon black surface-modified with a hydrophilic organic material, e.g., sulfonic acid, in a bipolar plate has been suggested. However, it can be difficult to ensure chemical stability of the hydrophilic inorganic material inside a fuel cell in which a series of oxidations and reductions continuously occur in this bipolar plate. As time goes by, the hydrophilic inorganic material undergoes separation from the carbon black, or chemical variation, thus causing deterioration in hydrophilicity or electrical conductivity of the bipolar plate.

### SUMMARY OF THE INVENTION

The present invention relates to a hydrophilic inorganic aggregate suitable for use in the production of a fuel cell bipolar plate with improved electrical conductivity and hydrophilicity and a method for preparing the hydrophilic inorganic aggregate. Furthermore, the present invention relates to a hydrophilic composite and a fuel cell bipolar plate, each comprising the hydrophilic inorganic aggregate.

In accordance with one aspect of the present invention, there is provided a hydrophilic inorganic aggregate comprising: hybrid particles having a structure in which carbon black particles are embedded on the surface of hydrophilic inorganic particles.

In the hydrophilic inorganic aggregate, the hydrophilic inorganic material may be zirconium dioxide, titanium dioxide, silicon dioxide, aluminum oxide, or a combination thereof.

The carbon black particles may have a diameter about 1/500 to about 1/10 of the diameter of the hydrophilic inorganic particles.

In accordance with another aspect of the present invention, there is provided a method for producing a hydrophilic inorganic aggregate, the method comprising forming hybrid particles having a structure in which carbon black particles are embedded on the surface of hydrophilic inorganic particles, by applying physical force to the carbon black particles on the surface of the hydrophilic inorganic particles.

In the method of producing the hydrophilic inorganic aggregate, the hybrid particles may be formed by particle-hybridization between the hydrophilic inorganic particle and the carbon black particles.

In accordance with another aspect of the present invention, there is provided a hydrophilic composite comprising: a resin binder comprising a thermoplastic or thermosetting resin; a conductive filler; and the hydrophilic inorganic aggregate according to one aspect of the present invention.

The hydrophilic composite may comprise: about 1 to about 45% by weight of the resin binder; about 50 to about 98% by weight of the conductive filler; and about 0.5 to about 45% by weight of the hydrophilic inorganic aggregate.

In the hydrophilic composite, the thermoplastic resin may be polyvinylidene fluoride, polycarbonate, nylon, polytetrafluoroethylene, polyurethane, polyester, polyethylene, polypropylene, polyphenylene sulfide, or a combination thereof, and the thermosetting resin may be epoxy resin, phenol resin, or a combination thereof.

The conductive filler may be a carbonic material comprising carbon black, carbon fiber, carbon nanotubes, graphite, or a combination thereof.

In accordance with another aspect of the present invention, there is provided a fuel cell bipolar plate produced from the hydrophilic composite according to another aspect of the present invention.

In accordance with yet another aspect of the present invention, there is provided a fuel cell bipolar plate comprising: a resin matrix comprising a thermoplastic or thermosetting resin; a conductive filler dispersed in the resin matrix; and the hydrophilic inorganic aggregate according to one aspect of the present invention dispersed in the resin matrix.

Details of other aspects and exemplary embodiments of the present invention are encompassed in the following detailed description.

### BRIEF DESCRIPTION OF THE DRAWINGS

The above and other aspects, features and other advantages of the present invention will be more clearly understood from the following detailed description taken in conjunction with the accompanying drawing, in which:

FIG. 1 is a schematic diagram illustrating the structure of a hybrid particle contained in a hydrophilic inorganic aggregate according to one embodiment of the present invention.

### DETAILED DESCRIPTION OF THE INVENTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

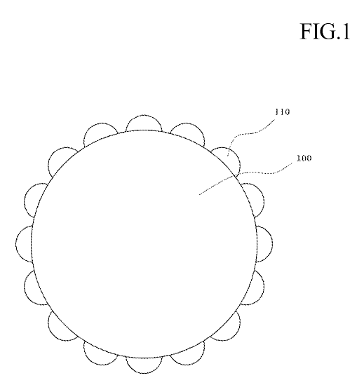

Referring to FIG. 1, a hydrophilic inorganic aggregate according to one embodiment of the present invention comprises a hybrid particle having a structure in which carbon black particles 110 are embedded on the surface of a hydrophilic inorganic particle 100.

FIG. 1 illustrating the structure of the hybrid particle, in which carbon black particles 110 are embedded on the surface of the hydrophilic inorganic particle 100, is given only for an illustrative purpose. That is to say, there is no limitation as to the embedment method of carbon black particles 110. More specifically, hybrid particles may be made by which carbon black particles are embedded on the surface of the hydrophilic inorganic particles by means of any method depending upon the shape and type of carbon black particles. For example, carbon black particles can be partly or entirely coated on the surface of the hydrophilic inorganic particles (stated differently, the surface of the hydrophilic inorganic particle can be partially or entirely coated with the carbon black particles).

The hydrophilic inorganic aggregate comprises hybrid particles, in which electrically conductive carbon black particles 110 are embedded on the surface of hydrophilic inorganic particles 100. In the case where the hydrophilic inorganic aggregate is used in a fuel cell bipolar plate, the hydrophilic inorganic aggregate can improve hydrophilicity while minimizing or preventing deterioration in electrical conductivity. In addition, the embedment of the carbon black particles 110 on the surface of the hydrophilic inorganic particles 100 ensures strong binding between the two components, and enables the hydrophilic inorganic particles, which are not significantly affected by oxidation and reduction, to be chemically stable inside the fuel cell. Accordingly, the use of the hydrophilic inorganic aggregate can ensure a stable improvement in electrical conductivity as well as hydrophilicity of the fuel cell bipolar plate.

In the hydrophilic inorganic aggregate, exemplary hydrophilic inorganic materials include without limitation zirconium dioxide, titanium dioxide, silicon dioxide, aluminum oxide, and combinations thereof. There is no limitation as to the inorganic material that can be used in the hydrophilic inorganic aggregate. Any inorganic material may be used without particular limitation so long as it is well-known to be hydrophilic and is substantially chemically stable.

Since the carbon black particles 110 are embedded on the surface of the hydrophilic inorganic particles 100, they have a diameter smaller than that of the hydrophilic inorganic particle 100. For example, the carbon black particles 110 may have a diameter about 1/10 or less than the diameter of the hydrophilic inorganic particle 100. As another example, the carbon black particles 110 may have a diameter about 1/500 to about 1/10 of the diameter of the hydrophilic inorganic particle 100. For example, the carbon black particles 110 can have a diameter of about 10 nm to about 100 μm.

The hydrophilic inorganic aggregate can include about 70 to about 30% inorganic particles and about 30 to about 70% carbon black particles. In exemplary embodiments of the invention, the hydrophilic inorganic aggregate can include at least about 50% or more inorganic particles, for example about 50% to about 70% inorganic particles, and about 50% or less carbon black particles, for example about 30% to about 50% carbon black particles. In other exemplary embodiments of the invention, the hydrophilic inorganic aggregate can include the inorganic particles as the majority component. Including inorganic particles and carbon black in the hydrophilic inorganic aggregate of the invention in the amounts noted herein can impart improved hydrophilicity to the hydrophilic inorganic aggregate while minimizing or preventing deterioration in electrical conductivity.

In accordance with another embodiment of the present invention, there is provided a method for producing a hydrophilic inorganic aggregate, the method comprising the step of forming hybrid particles, such that carbon black particles are embedded on the surface of hydrophilic inorganic particles, by applying physical force to the carbon black particles on the surface of the hydrophilic inorganic particles.

In the production of the hydrophilic inorganic aggregate, the hybrid particles, in which carbon black particles are embedded on the surface of the hydrophilic inorganic particles, are formed by particle-hybridization between the hydrophilic inorganic particle and the carbon black particles. Such particle-hybridization embeds the carbon black particles on the surface of the hydrophilic inorganic particles by applying physical pressing or shearing force on the surface of the hydrophilic inorganic particles. Examples of the particle-hybridization include, but not limited to: particle-hybridization via airflow disclosed in U.S. Pat. No. 6,892,475; and particle-hybridization via a blade disclosed in U.S. Pat. No. 4,789,105, the entire disclosure of each of which is incorporated by reference. Each of these US patents discloses specific means and apparatus for practicing the particle-hybridization. These well-known particle-hybridizations may be employed in the production of the hydrophilic inorganic aggregate comprising hybrid particles, in which carbon black particles are embedded on the surface of the hydrophilic inorganic particles, according to another embodiment of the present invention.

Any well-known particle-hybridization may be employed, however, without particular limitation so long as it is applicable for the embedment of carbon black particles on the surface of the hydrophilic inorganic particles via the application of physical force.

Constituent components of the hydrophilic inorganic aggregate produced in accordance with the fore-mentioned method are the same as described above.

In accordance with another embodiment of the present invention, there is provided a hydrophilic composite comprising: a resin binder comprising a thermoplastic or thermosetting resin; a conductive filler; and the hydrophilic inorganic aggregate according to one embodiment of the present invention.

The hydrophilic composite comprises the hydrophilic inorganic aggregate, in addition to the conductive filler. In the case where such a hydrophilic composite is used in a fuel cell bipolar plate, the hydrophilic composite can exhibit sufficient electrical conductivity. The inclusion of the hydrophilic inorganic aggregate in the hydrophilic composite can improve hydrophilicity without causing deterioration in the electrical conductivity when used in the production of the fuel cell bipolar plate. In addition, the hydrophilic inorganic particle can be chemically stable in the fuel cell where a series of oxidations and reductions continuously occur. Accordingly, the use of the hydrophilic composite can achieve a favorable improvement in electrical conductivity as well as hydrophilicity of the fuel cell bipolar plate.

The hydrophilic composite can include about 1 to about 45% by weight of the resin binder, about 50 to about 98% by weight of the conductive filler; and about 0.5 to about 45% by weight of the hydrophilic inorganic aggregate. The use of each constituent component of hydrophilic composite in an amount within the ranges defined herein can impart the desired characteristics, i.e., electrical conductivity and hydrophilicity, to the fuel cell bipolar plate.

In the hydrophilic composite, examples of the thermoplastic resin include without limitation polyvinylidene fluoride, polycarbonate, nylon, polytetrafluoroethylene, polyurethane, polyester, polyethylene, polypropylene, polyphenylene sulfide, and the like, and combinations thereof thereof. Examples of the thermosetting resin include without limitation epoxy resins, phenol resins, and the like, and combinations thereof. There is, however, no limitation as to the thermoplastic and thermosetting resins that can be used in the hydrophilic composite. Any thermoplastic or thermosetting resin may be used without particular limitation so long as it can be used as a resin matrix of a fuel cell bipolar plate.

The conductive filler imparts the desired electrical conductivity i.e., about 75 to about 100 S/cm, to the fuel cell bipolar plate. Any conductive filler may be used without particular limitation so long as it is well-known for use in a fuel cell bipolar plate. Examples of the conductive filler include without limitation carbonic conductive filler, metallic filler, and the like, and combinations thereof. The carbonic conductive filler can include without limitation carbon black, carbon fiber, carbon nanotubes, graphite, and the like, and combinations thereof.

In accordance with another embodiment of the present invention, there is provided a fuel cell bipolar plate produced from the hydrophilic composite according to another embodiment of the present invention. The fuel cell bipolar plate comprises a resin matrix comprising a thermoplastic or thermosetting resin; and a conductive filler and the hydrophilic inorganic aggregate according to one embodiment of the present invention, each being dispersed in the resin matrix.

The fuel cell bipolar plate has the desired hydrophilicity, while undergoing no or minimal deterioration in electrical conductivity, owing to uniform dispersion of the hydrophilic inorganic aggregate. The hydrophilicity of the fuel cell bipolar plate is caused by fine pores formed around the hydrophilic inorganic aggregate. In addition, chemical stability of the hydrophilic inorganic aggregate enables maintenance of the hydrophilicity and electrical conductivity of the fuel cell bipolar plate. Therefore, the fuel cell bipolar plate can exhibit improved hydrophilicity and electrical conductivity. These characteristics can be stably maintained.

The fuel cell bipolar plate may be obtained in accordance with conventional methods for producing a resin-based bipolar plate. For example, the fuel cell bipolar plate may be produced by hardening the resin binder via heating of the hydrophilic composite. In the production of the fuel cell bipolar plate, a hot press, etc., may be used.

The thermoplastic resin, thermosetting resin, and conductive filler that can be contained in the fuel cell bipolar plate can be the same as described above.

The present invention will be better understood from the following examples. However, these examples are not to be construed as limiting the scope of the invention.

### EXAMPLES

A thermoplastic resin, a conductive filler, and a hydrophilic inorganic aggregate are used in an amount shown in Tables 1 and 2, to produce each fuel cell bipolar plate of the following Examples 1 to 6 and Comparative Examples 1 to 7.

(1) Thermoplastic Resin

A polyphenylene sulfide resin (PPS) is used as a thermoplastic resin to form a resin matrix of the fuel cell bipolar plate. The polyphenylene sulfide used herein is Ryton PR-11® (available from Chevron Phillips Chemical (CPC) Company, LLC.) having a zero viscosity of 300 P measured under nitrogen atmosphere at 315.5° C.

(2) Conductive Filler

Artificial graphite (average diameter: 100 μm) is used as a carbonic conductive filler of the fuel cell bipolar plate.

(3) Hydrophilic Inorganic Aggregate

A hydrophilic inorganic aggregate comprising hybrid particles, in which nano-scale carbon black particles are embedded on the surface of micro-scale titanium dioxide particles, is used. The nano-scale carbon black particles have a surface area of 70 m²/g measured in accordance with ASTM D3037-89, and an average diameter of 35 nm after exposure to ultrasonic wave emitted from an ultrasonic emitter for 10 min. The micro-scale titanium dioxide particles have an average diameter of 5.3 μm obtained from controlled hydrolysis of titanium tetra-isopropoxide in accordance with the method disclosed in J. Phys. Chem. 98 (1994) 1366.

The production of hybrid particles is based on the particle-hybridization disclosed in U.S. Pat. No. 6,892,475.

Respective constituent components (1) to (3) are mixed together based on the amounts shown in Tables 1 and 2 to prepare a hydrophilic composite.

In Comparative Examples 2 to 4, conventional carbon black is used without undergoing any embedment on the surface of hydrophilic inorganic particles. In Comparative Examples 5 to 7, titanium dioxide is used alone. A haake mixer is used to prepare the hydrophilic composite.

Then, fuel cell bipolar plates of Examples 1 to 6 and Comparative Examples 1 to 7 are produced from hydrophilic composites by means of a hot press.

The electrical conductivity of each fuel cell bipolar plate is measured by 4-pin probe. The hydrophilicity of each fuel cell bipolar plate is evaluated on the basis of water uptake (W). A sample of each fuel cell bipolar plate is dried on an oven at 80° C. for 12 hours, following by weighing (W₁) Subsequently, the sample of each fuel cell bipolar plate is dipped into water at 25° C. for 8 hours, following by weighing (W₂). The water uptake is calculated by dividing the difference between W₁ and W₂ by W₁, in terms of percentage (%) by weight, which is demonstrated by Equation 1 below:

W(%)=100·(W₂−W₁)/W₁ (1)

The electrical conductivity and water uptake for respective bipolar plates measured are shown in Tables 1 and 2.

TABLE 1

| | Ex. | | | | | |
|---|---|---|---|---|---|---|
| | 1 | 2 | 3 | 4 | 5 | 6 |
| Thermoplastic resin | 25 | 25 | 25 | 25 | 25 | 25 |
| (wt. %) | | | | | | |
| Conductive filler | 70 | 65 | 60 | 70 | 65 | 60 |
| (wt. %) | | | | | | |
| Hydrophilic inorganic | 5 | 10 | 15 | — | — | — |
| aggregate A¹⁾ (wt. %) | | | | | | |
| Hydrophilic inorganic | — | — | — | 5 | 10 | 15 |
| aggregate B²⁾ (wt. %) | | | | | | |
| Electrical conductivity | 99 | 113 | 117 | 94 | 83 | 71 |
| (S/cm) | | | | | | |
| Water intake (wt. %) | 7.3 | 8.2 | 9.1 | 7.5 | 8.9 | 10.7 |

¹⁾Hydrophilic inorganic aggregate A - carbon black particles:titanium dioxide particles = 1:1 (w/w)
²⁾Hydrophilic inorganic aggregate B - carbon black particles:titanium dioxide particles = 1:2 (w/w)

TABLE 2

| | Comp. Ex. | | | | | | |
|---|---|---|---|---|---|---|---|
| | 1 | 2 | 3 | 4 | 5 | 6 | 7 |
| Thermoplastic resin | 25 | 25 | 25 | 25 | 25 | 25 | 25 |
| (wt. %) | | | | | | | |
| Conductive filler | 75 | 70 | 65 | 60 | 72.5 | 70 | 67.5 |
| (wt. %) | | | | | | | |
| Carbon black (wt. %) | — | 5 | 10 | 15 | — | — | — |
| Titanium dioxide | — | — | — | — | 2.5 | 5 | 7.5 |
| (wt. %) | | | | | | | |
| Electrical conductivity | 103 | 115 | 123 | 110 | 83 | 68 | 41 |
| (S/cm) | | | | | | | |
| Water intake (wt. %) | 6.0 | 5.8 | 6.2 | 5.5 | 6.8 | 7.9 | 8.4 |

As can be seen from the data in Tables 1 and 2, the bipolar plates of Examples 1 to 6, each including hydrophilic inorganic aggregate of the invention, exhibit improved hydrophilicity, without undergoing any significant deterioration in electrical conductivity. Meanwhile, the bipolar plates of Examples 1 to 6 exhibit considerably improved hydrophilicity, while undergoing slight deterioration in electrical conductivity, when compared to the bipolar plates of Comparative Examples 5 to 7, in which a hydrophilic inorganic material (e.g., titanium dioxide) is used alone.

Many modifications and other embodiments of the invention will come to mind to one skilled in the art to which this invention pertains having the benefit of the teachings presented in the foregoing descriptions. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation, the scope of the invention being defined in the claims.

That which is claimed is:

1. A hydrophilic inorganic aggregate comprising:
hybrid particles having a structure in which carbon black particles are embedded on the surface of hydrophilic inorganic particles.

2. The hydrophilic inorganic aggregate according to claim 1, wherein the hydrophilic inorganic particles comprise zirconium dioxide, titanium dioxide, silicon dioxide, aluminum oxide, or a combination thereof.

3. The hydrophilic inorganic aggregate according to claim 1, wherein the carbon black particles have a diameter about 1/500 to about 1/10 of the diameter of the hydrophilic inorganic particles.

4. The hydrophilic inorganic aggregate according to claim 1, comprising about 70 to about 30% of the inorganic particles and about 30 to about 70% of the carbon black particles.

5. The hydrophilic inorganic aggregate according to claim 4, comprising about 50% to about 70% of the inorganic particles and about 30% to about 50% of the carbon black particles.

6. The hydrophilic inorganic aggregate according to claim 1, comprising the inorganic particles as a majority component.

7. A method for producing a hydrophilic inorganic aggregate, the method comprising:
forming hybrid particles, such that carbon black particles are embedded on the surface of hydrophilic inorganic particles, by applying physical force to the carbon black particles on the surface of the hydrophilic inorganic particle.

8. The method according to claim 7, wherein the formation of the hybrid particles is carried out by particle-hybridization between the hydrophilic inorganic particles and the carbon black particles.

9. The method according to claim 7, wherein the hydrophilic inorganic particles comprise zirconium dioxide, titanium dioxide, silicon dioxide, aluminum oxide, or a combination thereof.

10. The method according to claim 7, wherein the carbon black particles have a diameter about 1/500 to about 1/10 of the diameter of the hydrophilic inorganic particles.

11. The method according to claim 7, wherein the hydrophilic inorganic aggregate comprises about 70 to about 30% of the inorganic particles and about 30 to about 70% of the carbon black particles.

12. The method according to claim 11, wherein the hydrophilic inorganic aggregate comprises about 50% to about 70% of the inorganic particles and about 30% to about 50% of the carbon black particles.

13. The method according to claim 7, wherein the hydrophilic inorganic aggregate comprises the inorganic particles as a majority component.

14. A hydrophilic composite comprising:
a resin binder comprising a thermoplastic or thermosetting resin;
a conductive filler; and
a hydrophilic inorganic aggregate comprising hybrid particles having a structure in which carbon black particles are embedded on the surface of hydrophilic inorganic particles.

15. The hydrophilic composite according to claim 14, wherein the hydrophilic composite comprises:
about 1 to about 45% by weight of the resin binder;
about 50 to about 98% by weight of the conductive filler; and
about 0.5 to about 45% by weight of the hydrophilic inorganic aggregate.

16. The hydrophilic composite according to claim 14, wherein the thermoplastic resin comprises polyvinylidene fluoride, polycarbonate, nylon, polytetrafluoroethylene, polyurethane, polyester, polyethylene, polypropylene, polyphenylene sulfide, or a combination thereof, and the thermosetting resin comprises epoxy resin, phenol resin, or a combination thereof.

17. The hydrophilic composite according to claim 14, wherein the conductive filler comprises a carbonic material comprising carbon black, carbon fiber, carbon nanotubes, graphite, or a combination thereof.

18. The hydrophilic composite according to claim 14, wherein the hydrophilic inorganic aggregate comprises about 70 to about 30% of the inorganic particles and about 30 to about 70% of the carbon black particles.

19. The hydrophilic composite according to claim 18, wherein the hydrophilic inorganic aggregate comprises about 50% to about 70% of the inorganic particles and about 30% to about 50% of the carbon black particles.

20. The hydrophilic composite according to claim 14, wherein the hydrophilic inorganic aggregate comprises the inorganic particles as a majority component.

21. A fuel cell bipolar plate produced from the hydrophilic composite according to claim 14.

22. A fuel cell bipolar plate comprising:
a resin matrix comprising a thermoplastic or thermosetting resin;
a conductive filler dispersed in the resin matrix; and
a hydrophilic inorganic aggregate comprising hybrid particles having a structure in which carbon black particles are embedded on the surface of hydrophilic inorganic particles dispersed in the resin matrix.

23. The fuel cell bipolar plate according to claim 22, wherein the thermoplastic resin comprises polyvinylidene fluoride, polycarbonate, nylon, polytetrafluoroethylene, polyurethane, polyester, polyethylene, polypropylene, polyphenylene sulfide, or a combination thereof, and the thermosetting resin comprises epoxy resin, phenol resin, or a combination thereof.

24. The fuel cell bipolar plate according to claim 22, wherein the conductive filler comprises a carbonic material comprising carbon black, carbon fiber, carbon nanotubes, graphite, or a combination thereof.

25. The fuel cell bipolar plate according to claims 22, wherein the hydrophilic inorganic aggregate comprises about 70 to about 30% of the inorganic particles and about 30 to about 70% of the carbon black particles.

26. The fuel cell bipolar plate according to claims 25, wherein the hydrophilic inorganic aggregate comprises about 70 to about 50% of the inorganic particles and about 30 to about 50% of the carbon black particles.

27. The fuel cell bipolar plate according to claims 22, wherein the hydrophilic inorganic aggregate comprises the inorganic particles as a majority component.
